(19) United States
(12) Patent Application Publication
(10) Pub. No.: US 2025/0202721 A1
(43) Pub. Date: Jun. 19, 2025

(54) MEASURING DISCRETE COMPONENT PROPERTIES TO ESTABLISH A PRINTED CIRCUIT BOARD FINGERPRINT

(71) Applicant: Cryptography Research, Inc., San Jose, CA (US)

(72) Inventors: Joel Wittenauer, Pleasanton, CA (US); Matthew E. Orzen, San Francisco, CA (US); Gilbert Goodwill, San Francisco, CA (US)

(21) Appl. No.: 18/974,508

(22) Filed: Dec. 9, 2024

Related U.S. Application Data
(60) Provisional application No. 63/611,824, filed on Dec. 19, 2023.

(51) Int. Cl. H04L 9/32

(52) U.S. Cl. CPC H04L 9/3278; H04L 9/3247; H04L 9/3268

(57) ABSTRACT

A method for measuring discrete component properties to establish a printed circuit board (PCB) fingerprint includes determining a physical measurement of an electronic device of the PCB; comparing the determined physical measurement to a predefined range for the physical measurement of the electronic device; and responsive to the determined physical measurement being within the predefined range, generating a digital certificate. The digital certificate includes the determined physical measurement. The determined physical measurement is capable of being extracted from the digital certificate to verify whether the electronic device is authentic or is failing.

### CLAIM OF PRIORTY

The present application claims the benefit under 35 U.S.C. § 119(e) of U.S. Provisional Patent Application No. 63/611,824 filed Dec. 19, 2023, which is incorporated by reference herein.

### BACKGROUND

Electronic systems, including printed circuit boards (PCBs), include multiple electronic devices, such as electronic circuits or electronic components. The quality of an electronic system often depends on the quality of the electronic devices that make up the electronic system. The same type of electronic device can vary in quality depending on whether the electronic device is authentic or is a clone.

### BRIEF DESCRIPTION OF THE DRAWINGS

The present disclosure is illustrated by way of example, and not by way of limitation, in the figures of the accompanying drawings.

FIG. 1 depicts a block diagram of an example system architecture, according to aspects of the present disclosure.

FIG. 2 depicts a flow diagram of an example method for measuring discrete component properties to establish a printed circuit board (PCB) fingerprint, according to aspects of the present disclosure.

FIG. 3 depicts a block diagram of an example PCB, according to aspects of the present disclosure.

FIG. 4 depicts a block diagram of another example PCB, according to aspects of the present disclosure.

FIG. 5 depicts a flow diagram of an example method for authenticating a PCB fingerprint, according to aspects of the present disclosure.

FIG. 6 depicts a block diagram of another example PCB, according to aspects of the present disclosure.

FIG. 7 is a block diagram illustrating an exemplary computer system, according to aspects of the present disclosure.

### DETAILED DESCRIPTION

The embodiments described herein describe technologies for measuring discrete component properties to establish a printed circuit board (PCB) fingerprint. The following description sets forth numerous specific details, such as examples of specific systems, components, methods, and so forth, in order to provide a good understanding of several implementations of the present disclosure. It will be apparent to one skilled in the art, however, that at least some implementations of the present disclosure may be practiced without these specific details. In other instances, well-known components or methods are not described in detail or presented in simple block diagram format to avoid unnecessarily obscuring the present disclosure. Thus, the specific details set forth are merely examples. Implementations may vary from these example details and still be contemplated to be within the scope of the present disclosure.

In general, an electronic system, which may include a PCB, can be assembled from various electronic devices, such as integrated circuits (ICs), microcontrollers, or other electronic components. However, it can be difficult to distinguish between a genuine electronic device and a “clone” electronic device of the same type. A clone electronic device may include an electronic device that is intended to replace a genuine electronic device, often without a user of the electronic device knowing that the clone is a clone. Even if two electronic devices appear identical, one may be a clone. Clone electronic devices are often of inferior quality, which may result in a clone having a shorter longevity or being less accurate or reliable than its genuine counterpart. Thus, parties that assemble electronic systems and parties that purchase assembled electronic systems often desire to know whether the electronic devices are genuine.

Cloned devices are often built at foundries that are different than genuine devices. These foundries often use different subcomponents than those of genuine devices, such as transistors of different sizes and geometry. The inherent differences in the construction of the cloned devices typically cause measurable differences in timing, power consumption, or other characteristics when compared to such characteristics of a genuine device. These differences are not necessarily noticeable from a visual inspection or when using the cloned device under normal conditions. If, however, one controls the operational conditions for a clone device and measures behavioral properties of the clone device, one may be able to determine that the electronic device is operating outside the operational range set by the genuine device's manufacturer.

The problem of clone electronic devices is a concern at many different points along a supply chain of an electronic system. For the manufacturer of the electronic system, the manufacturer may want to know that the electronic devices it is using to assemble the electronic system are genuine. For a supplier or retailer downstream from the manufacturer, such parties may want to know whether they are selling electronic systems with genuine components, or they may want to know whether somewhere along the supply chain a party has surreptitiously replaced genuine devices with clone devices. Similarly, end users of electronic systems may want to know whether the electronic systems they have purchased are composed of genuine components.

Additionally or alternatively, parties that use or sell electronic systems may desire to know whether electronic devices of those systems are failing. An electronic device may fail in response to high usage, age, improper assembly, a manufacturing defect, or other reasons. Similar to detecting clone electronic devices, it can be difficult to determine, by a visual inspection or using the electronic device under normal conditions, whether an electronic device is failing.

Aspects of the disclosure address at least the above challenges among others by implementing a system to verify whether an electronic device of an electronic system is authentic or failing. The system may include software, hardware, or a combination of software and hardware that measure a physical measurement or a side channel of an electronic device. The measuring process may include operating the electronic device under certain conditions and measuring a power consumption, a response time, a clock parameter, an accuracy, statistical properties of physical measurements, sets of physical measurements, or other types of physical measurements of the electronic device. The system may use one or more of these measurements to determine one or more characteristics of the measurement or side channel (e.g., an average measurement or a differential measurement). The system may compare the determined physical measurement or characteristic to a range for the physical measurement of the electronic device. The range may be provided by the manufacturer of the electronic device or some other party with data regarding operational parameters of a genuine electronic device. The range may change over time and, in some implementations, change in a predictable way (e.g., the range may be adjusted for an age of the electronic device). The system may generate a digital certificate that includes the determined physical measurement. The determined physical measurement may be extractable from the digital certificate. At a later time, the system may perform the physical measurement again on the electronic device and compare this second determined physical measurement to the physical measurement extracted from the digital certificate. If the second determined physical measurement is within a tolerance range, then the system may determine that the electronic device is still genuine and was not later replaced by a clone. However, if the second determined physical measurement is not within the tolerance range, this may indicate that the electronic device has been replaced by a clone since the time the digital certificate was generated or that the electronic device is failing.

As noted, a technical problem addressed by implementations of the disclosure is that electronic devices of an electronic system may be surreptitiously replaced by inferior quality clones or may be failing, and it may be difficult to determine from a visual inspection whether the electronic devices are genuine or failing. A technical solution to the above identified technical problems can include performing the steps described above. The digital certificate generated by the system is a cryptographically secure mechanism by which the authenticity of an electronic device can be determined. Thus, the systems and methods described herein result in more secure electronic devices and electronic devices of higher quality, including in qualities such as power consumption, response time, and accuracy. The systems and methods described herein result in detecting failing electronic devices.

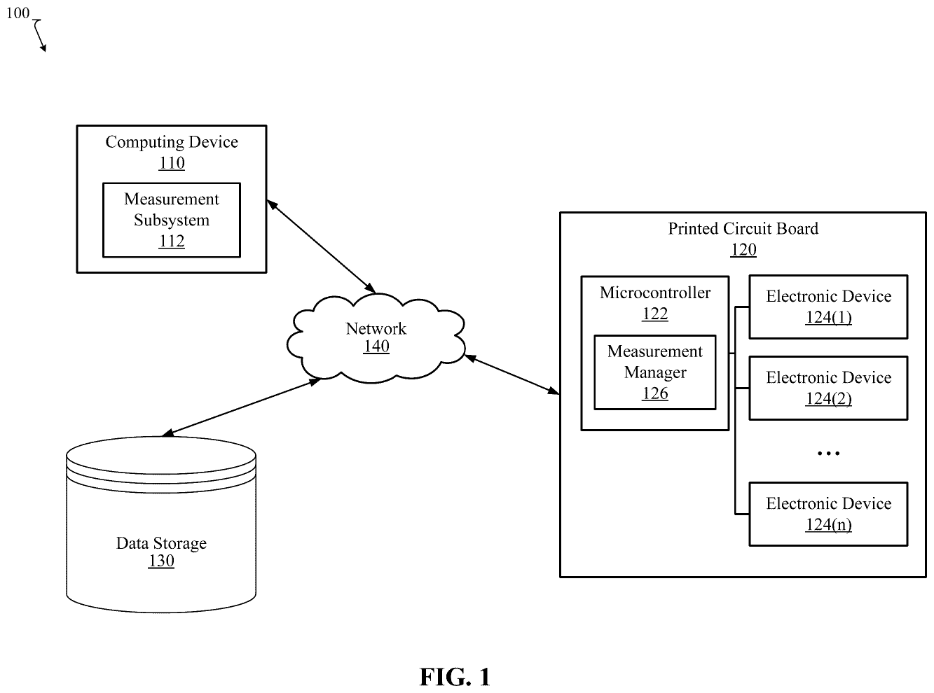

FIG. 1 depicts an illustrative system architecture 100, according to aspects of the present disclosure. Computer system architecture 100 includes a computing device 110, a PCB 120, a data storage 130, and a network 140. The computing device 110, the PCB 120, and the data storage 130 are connected to each other in data communication by the network 140. The computing device 110 may include a measurement subsystem 112. The PCB 120 may include a microcontroller 122. The PCB 120 may include one or more electronic devices 124(1)-(n). The PCB 120 may include a measurement manager 126.

The computing device 110 may include one or more computing devices. In some implementations, a computing device may include a physical computing device or may include a virtualized component, such as a virtual machine (VM) or a container. A computing device may include an instance of a computing device. An instance of a computing device may include a spun-up instance that may not be specific to any computing device. In some implementations, a VM may include a system virtual machine, which may include a VM that emulates an entire physical computing device. A VM can include a process virtual machine, which may include a VM that emulates an application or some other software. A container may include a computing environment that logically surrounds one or more software applications independently of other applications executing in the cloud computing environment.

A cloud computing system may include one or more computing devices (or portions of cloud computing devices) provided to an end user by a cloud provider. An end user of the environment may utilize a portion of the cloud computing system to host content for use or access by other parties or perform other computational tasks. In some implementations, the cloud computing system may be configured to allow the end user to use a portion of a computing device (e.g., only certain hardware, software, or other computer system resources). The cloud computing environment may include a private cloud, a public cloud, or a hybrid cloud. The cloud computing environment may provide infrastructure-as-a-service (IaaS), platform-as-a-service (PaaS), or software-as-a-service (SaaS) computing. The cloud computing environment may provide serverless computing.

In some implementations, the measurement subsystem 112 may include software, hardware, or a combination of software and hardware. The measurement subsystem 112 may be configured to coordinate data between the computing device 110, the microcontroller 122 (including the measurement manager 126), or the data storage 130. Coordinating the data may include the measurement subsystem 112 sending a command or other data to the microcontroller 122 to perform electronic device physical measurement operations, discussed herein. The measurement subsystem 112 may send the command or other data in response to a user input to the computing device 110. The measurement subsystem 112 may be configured to receive data from the microcontroller 122 (e.g., a digital certificate generated by the measurement manager 126). The measurement subsystem 112 may display information on a display device of the computing device 110 based on the received data. The measurement subsystem 112 may be configured to send data to or receive data from the data storage 130.

In one implementation, the PCB 120 may include a thin board that may be made of some type of insulating material, such as fiberglass. The PCB 120 may include one or more conducting traces etched into the insulating material that may connect the microcontroller 122 or the one or more electronic devices 124(1)-(n) to each other. The conducting traces may be made of an electrically conductive material such as copper. The microcontroller 122 or the one or more electronic devices 124(1)-(n) may be soldered to the PCB 120.

In some implementations, the microcontroller 122 may include a self-contained computer on a single integrated circuit (IC) that is designed to perform specific tasks within electronic systems. The microcontroller 122 may include the functions of a central processing unit (CPU), computer memory, or input/output (I/O) peripherals. The microcontroller 122 may include one or more programs, such as an embedded program, firmware, or software. The one or more programs may execute on the microcontroller 122.

In one or more embodiments, an electronic device 124 of the one or more electronic devices 124(1)-(n) may include an electronic circuit, an electronic component, or some other type of electronic device. The electronic device(s) 124(1)-(n) may include devices such as ICs. The electronic device(s) 124(1)-(n) may include resistors, capacitors, inductors, transistors, diodes, sensors, actuators, or other types of electronic devices. In some implementations, an electronic device 124 may not include properties that the microcontroller 122 or another device can interrogate directly to determine whether the electronic device 124 is genuine.

In some embodiments, the measurement manager 126 may include software, hardware, or a combination of software and hardware. The measurement manager 126 may include an embedded program. The measurement manager 126 may be configured to determine a physical measurement of an electronic device 124, compare the determined physical measurement to a predefined range for the physical measurement, and generate a digital certificate that includes the physical measurement. The measurement manager 126 may be configured to perform other operations, discussed herein.

In one implementation, the data storage 130 may be hosted by one or more data storage devices. A data storage device may include volatile storage or nonvolatile storage. The data storage 130 may include main memory, magnetic or optical storage-based disks, tapes or hard drives, network-attached storage (NAS), a storage area network (SAN), or the like. In some implementations, the data storage 130 may include a network-attached file server, an object-oriented database, a relational database, or the like. The data storage 130 may be hosted by a cloud-based environment or one or more different machines coupled to the cloud-based environment. In some implementations, the data storage 130 may include a data storage device hosted on an external computing device, e.g., a computing device other than the computing device 110 or a device other than the PCB 120 that is still in data communication with the computing device 110 (e.g., over the network 140).

In one or more implementations, the network 140 may include a public network (e.g., the Internet), a private network (e.g., a local area network (LAN) or wide area network (WAN)), or a combination thereof. The network 140 may include a wireless infrastructure, which may be provided by one or more wireless communications systems, such as a wireless networking hotspot connected with the network 140 or a wireless carrier system that may be implemented using various data processing equipment, communication towers, etc. Additionally, or alternatively, the network 140 may include a wired infrastructure (e.g., Ethernet).

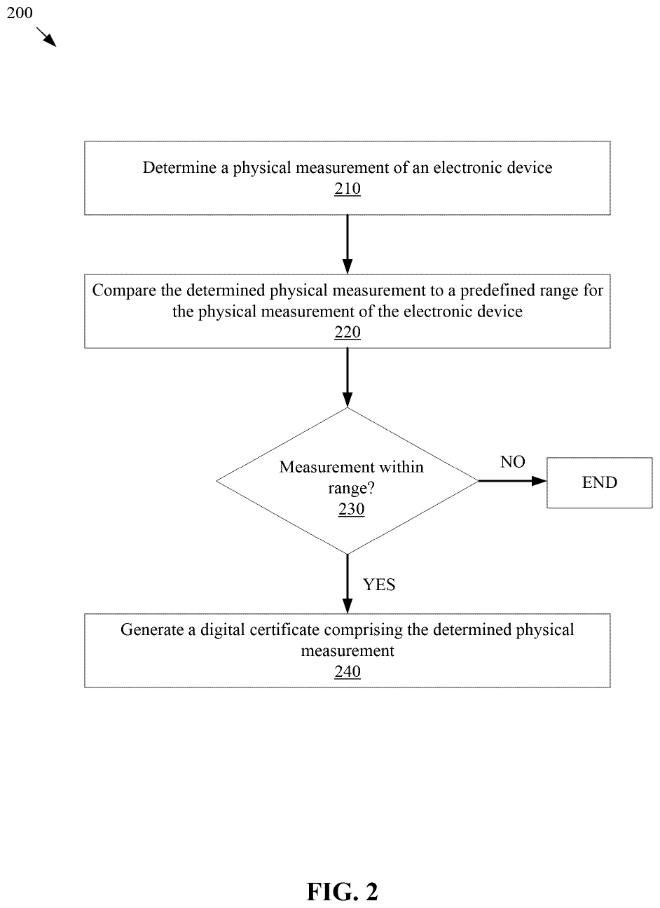

FIG. 2 depicts a flow diagram of an example method 200 for measuring discrete component properties to establish a PCB fingerprint, in accordance with some implementations of the disclosure. The individual functions, routines, subroutines, or operations of the method 200 may be performed by a microcontroller, such as the microcontroller 122. The method 200 may be performed by a processing device, having one or more CPU(s) and memory devices communicatively coupled to the CPU(s). In some implementations, the method 200 may be performed by a single processing thread or alternatively by two or more processing threads, each thread executing one or more individual functions, routines, subroutines, or operations of the method. The method 200, as described below, may be performed by processing logic that may include hardware (e.g., a processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible. In some implementations, the same, different, fewer, or greater operations may be performed. It is noted that elements of FIG. 1 may be used herein to help describe FIG. 2. In some implementations, the measurement manager 126 may perform one or more of the operations of the method 200.

At operation 210, processing logic determines a physical measurement of an electronic device. The electronic device may include an electronic device 124 of the one or more electronic devices 124(1)-(n) of the PCB 120.

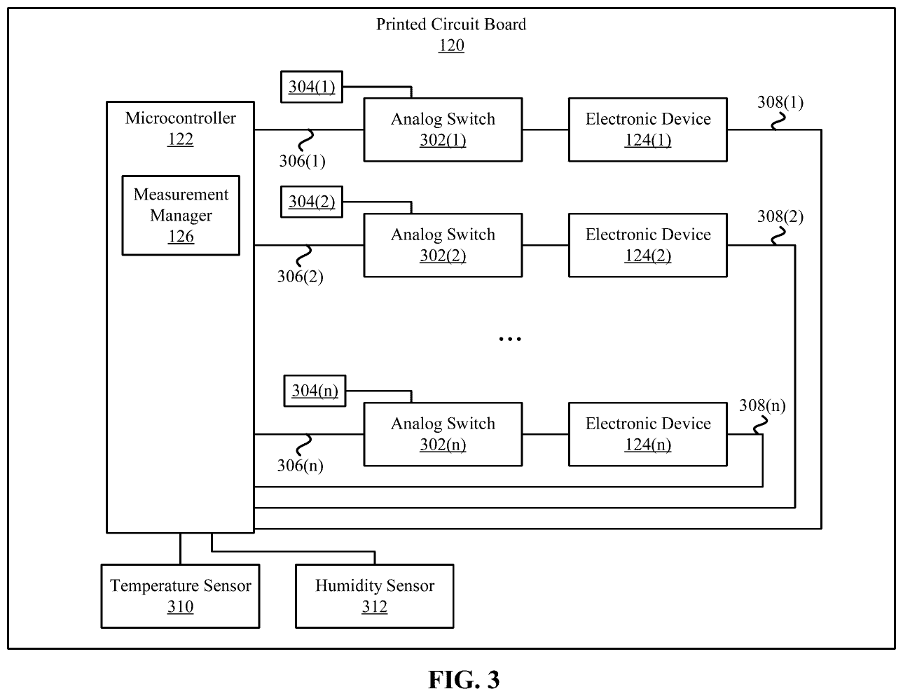

FIG. 3 depicts an illustrative PCB 120. As can be seen in FIG. 3, in some implementations, the PCB 120 may include one or more analog switches 302(1)-(n), one or more power supply lines 304(1)-(n), one or more channels 306(1)-(n), or one or more sense resistors 308(1)-(n). The microcontroller 122 may connect to an electronic device 124 through an analog switch 302. An analog switch 302 may include an electronic component that allows a signal to be passed from the microcontroller 122 to the electronic device 124. The analog switch 302 may select one of several input signals to be applied to the electronic device 124.

In one or more implementations, a power supply line may connect to an analog switch 302. The power supply line 304 may provide electrical power to an electronic device 124 connected to the same analog switch 302. In some implementations, the analog switch 302 may tie a connected electronic device's input voltage to either the microcontroller 122 or the connected power supply line 304, depending on a signal from the microcontroller 122.

In one or more implementations, a channel 306 may connect the microcontroller 122 to an analog switch 302. The channel 306 may include a digital-to-analog (D2A) channel. The channel 306 may include a general-purpose I/O (GPIO) pin. The channel 306 may include other communication media between the microcontroller 122 and the analog switch 302.

In some implementations, a sense resistor 308 may be connected to an electronic device 124 and to an analog-to-digital (A2D) channel of the microcontroller 122. The sense resistor may include a resistor that is connected to a ground plane of the PCB 120. The voltage drop across a sense resistor 308 may be proportional to the current flowing from the connected electronic device 124 to a ground. The voltage drop across the sense resistor 308 may be tied to the connected A2D channel of the microcontroller 122. As the electronic device's 124 supply voltage is varied under different operations, the electronic device's 124 power consumption can be measured by the microcontroller 122 using the relevant sense resistor 308.

Returning to FIG. 2, in one implementation, the physical measurement of the operation 210 may include a power consumption of the electronic device 124. Determining the physical measurement of the electronic device 124 may include setting a supply voltage of the electronic device 124 to a predetermined value and measuring the power consumption of the electronic device during execution of one or more electronic device operations. An electronic device operation may include reading data from the electronic device 124, writing data to the electronic device 124, or deleting data from the electronic device 124. Setting the supply voltage may include the microcontroller 122 sending a signal to the analog switch 302 over the channel 306 and, in response, the analog switch 302 switching from supplying power to the electronic device 124 using the power supply line 304 to supplying power to the electronic device 124 using a voltage line of the channel 306. The microcontroller 122 may measure a voltage drop across the sense resistor 308 to measure the electronic device's 124 power consumption during the electronic device operations.

In one implementation, the predetermined value may include the manufacturer's lowest permissible value for the electronic device's 124 supply voltage. The predetermined value may include the manufacturer's highest permissible value for the electronic device's 124 supply voltage. The predetermined value may include a voltage between the manufacturer's lowest permissible value and the manufacturer's highest permissible value for the electronic device's 124 supply voltage. The manufacturer may include the manufacturer of the electronic device 124. In some implementations, the measurement manager 126 may obtain the manufacturer's lowest permissible value or the manufacturer's highest permissible value from the measurement subsystem 112, the data storage 130, or some other data source. In some implementations, the predetermined value may be adjusted based on an age of the electronic device 124. The age of the electronic device 124 may be determined as a time from when the electronic device 124 was manufactured, the time the electronic device 124 has been in use, or some other time measurement.

In some implementations, the physical measurement may include a clock parameter of the electronic device 124. In one implementation, determining the physical measurement of the electronic device 124 may include sending data to the electronic device 124 and measuring a response time of the electronic device 124.

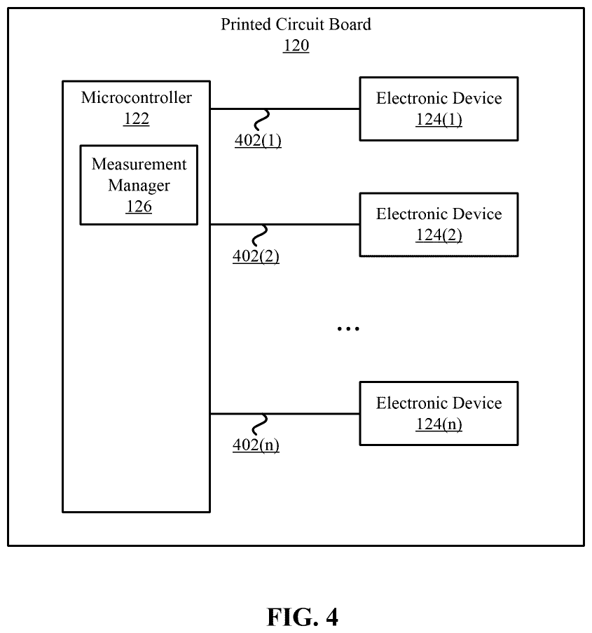

FIG. 4 depicts an illustrative PCB 120. As can be seen in FIG. 4, the PCB 120 may include one or more communication lines 402(1)-(n). A communication line 402 may include a signal trace. A communication 402 line may connect a communications interface of the microcontroller 122 to an electronic device 124. A communication interface may include a Small Computer System Interface (SCSI), Inter-Integrated Circuit (I2C) interface, or some other interface. The communication line 402 may send data from the microcontroller 122 to the electronic device 124, and the communication line 402 may send data from the electronic device 124 to the microcontroller 122.

Sending data to the electronic device 124 may include sending data from the microcontroller 122 over a communication line 402 to the electronic device 124. The data may include a command to modify the clock of the electronic device 124. The data may include a command for the electronic device 124 to execute an electronic device operation. Measuring the response time may include the microcontroller 122 determining whether the electronic device responded to the data within a time limit based on the modified clock. The response time may include determining whether the clock of the electronic device 124 is within a tolerance window. Measuring the response time may include measuring how quickly the electronic device responded to the data. A response time of the electronic device 124 may include a time between the electronic device 124 receiving the data and the electronic device 124 producing a responsive output. In some implementations, the microcontroller 122 may measure the timing of a voltage drop across the sense resistor 308 to measure the response time.

In one implementation, the physical measurement may include a response time of the electronic device 124. Determining the physical measurement of the electronic device 124 may include measuring the response time of the electronic device during execution of one or more electronic device operations. The microcontroller 122 may send a command for the electronic device to perform the one or more electronic device operations over a communication line 402 to the electronic device 124. The response time of the electronic device 124 may include a time between the electronic device 124 receiving the command to perform the execution of an electronic device operation and the electronic device 124 producing an output in response to the execution of the electronic device operation. In some implementations, determining the physical measurement may include setting a supply voltage of the electronic device 124 to a predetermined value. The response time of the electronic device 124 may depend, at least in part, on the supply voltage of the electronic device 124. The microcontroller 122 may measure the timing of a voltage drop across the sense resistor 308 to measure the response time.

In some implementations, the physical measurement may include an accuracy of the electronic device 124. In one implementation, the accuracy of the electronic device 124 may include a write accuracy (e.g., how well does the electronic device 124 write the data it is commanded to write). Determining the physical measurement of the electronic device 124 may include writing a block of data to the electronic device 124, reading the block of data from the electronic device 124, and determining how closely the written block of data matches the read block of data. In one implementation, the accuracy of the electronic device 124 may include a read accuracy (e.g., how well does the electronic device 124 read the data it is commanded to read). Determining the physical measurement may include determining how closely a read block of data matches the data actually stored in the block of data. For example, the physical measurement may include a value between “0” and “1” where “0” indicates that the read block of data and the actual block of do not share any common data, and “1” indicates a perfect match. In one implementation, the accuracy of the electronic device 124 may include an erase accuracy (e.g., how well does the electronic device 124 erase data). Determining the physical measurement of the electronic device 124 may include erasing a block of data from the electronic device 124, reading the location in the electronic device 124 where the block of data was stored, and determining whether the block of data was actually erased. Erasing the block of data may include overwriting the location where the block of data was stored with other data (e.g., “garbage” values or null data). In some implementations, the microcontroller 122 may send a command for the electronic device to perform the write, read, or erase command over a communication line 402 to the electronic device 124. Determining the physical measurement may include the microcontroller 122 receiving the read block of data from the electronic device 124 using the communication line 402.

In some implementations, the PCB 120 may include a temperature sensor 310. In one implementation, the PCB 120 may include a humidity sensor 312. In some cases, a temperature or a humidity around the PCB 120 may affect the accuracy of a determined physical measurement. Thus, in one implementation, at operation 210, processing logic may receive a temperature measurement from the temperature sensor 310 and adjust the determined physical measurement based on the temperature measurement. In some implementations, at operation 210, processing logic may receive a humidity measurement from a humidity sensor 312 and adjust the determined physical measurement based on the humidity measurement.

In one implementation, determining the physical measurement of the electronic device 124 may include determining multiple physical measurements of a single electronic device 124. For example, the measurement manager 126 may determine a response time of an electronic device 124(1) and a power consumption of the same electronic device 124(1).

Referring again to FIG. 2, at operation 220, processing logic compares the determined physical measurement to a predefined range for the physical measurement of the electronic device 124. In one implementation, the measurement manager 126 may receive the predefined range from the computing device 110. The measurement subsystem 112 of the computing device 110 may send data that includes predefined ranges, and the measurement manager 126 may select the predefined range that corresponds to the electronic device 124 from which the physical measurement was taken. The predefined ranges may have been generated by manufacturers of the electronic devices 124(1)-(n). In some implementations, the measurement subsystem 112 may retrieve the predefined ranges from the data storage 130. The data storage 130 may include one or more databases operated by one or more manufactures of the electronic devices 124(1)-(n). In other implementations, the measurement subsystem 112 may cause the data storage 130 to send the predefined ranges to the microcontroller 122.

At operation 230, processing logic determines whether the determined physical measurement is within the predefined range. Responsive to the determined physical measurement being within the predefined range, at operation 240, processing logic generates a digital certificate. Generating the digital certificate may include generating a cryptographic key pair derived from the determined physical measurement and using the cryptographic key pair to sign the digital certificate, as explained further below. The digital certificate may include the determined physical measurement. The digital certificate may attest that the electronic device 124 from which the determined physical measurement was taken is authentic. The digital certificate may attest that the electronic device 124 from which the determined physical measurement was taken is not failing. The determined physical measurement may be extracted from the digital certificate to verify whether the electronic device 124 is authentic or is not failing.

In one implementation, the measurement manager 126 may generate the digital certificate. The measurement manager 126 may include a cryptographic key pair and may use the key pair to generate the digital certificate. The key pair may include a public key and a private key. The measurement manager 126 may include the public key in the digital certificate so that another entity can use the public key to verify the digital certificate.

In some implementations, the method 200 may further include generating, based on the determined physical measurement, a cryptographic key pair that includes a public key and a private key. In one implementation, the measurement manager 126 may include a key derivation function or some other key generation function. The key derivation function may accept, as input, the determined physical measurement. The key derivation function may use the determined physical measurement (and, in some cases, other data) to generate the cryptographic key pair. The measurement manager 126 may include the public key in the digital certificate. The measurement manager 126 may sign the digital certificate using the private key. In some implementations, the measurement manager 126 may send the digital certificate to the measurement subsystem 112. The measurement system 112 may use the digital certificate to verify the signature was generated using the private key that corresponds to the public key of the cryptographic key pair. This may help verify that the measurement manager 126 possesses the corresponding private key.

In one implementation, the measurement manager 126 may store the digital certificate. In one or more implementations, the measurement manager 126 may store the digital certificate in a memory accessible to the PCB 120. A memory accessible to the PCB 120 may include a memory located on the PCB 120 or on the microcontroller 122. In some implementations, the measurement manager 126 may send the digital certificate to the measurement subsystem 112. The measurement subsystem 112 may store the digital certificate. The measurement subsystem 112 may store the digital certificate in the data storage 130. In some implementations, the measurement manager 126 may send the physical measurement to the measurement subsystem 112 of the computing device 110. The measurement subsystem 112 may perform some of the operations of the operation 230 described above, such as generating the digital certificate, generating the cryptographic key pair, signing the digital certificate, etc.

In some implementations, the microcontroller 122 may perform one or more operations 210-230 of the method 200 during each boot process of the microcontroller 122. In this manner, the measurement manager 126 or another component of the PCB 120 may, during a boot process, use the contents of the digital certificate to determine if an electronic device's 124 measurement(s) are within an acceptable range, which may aid a user of the PCB 120 in detecting whether an electronic device 124 has been replaced by a clone or is failing sooner than if the operations 210-230 are performed at some other time interval. Responsive to the measurement manager 126 or other component of the PCB 120 not detecting the digital certificate or detecting that a measurement of an electronic device 124 is not within an acceptable range, the microcontroller 122 may not complete the boot process or may boot in a limited state.

In one implementation, the method 200 may further include the measurement manager 126 verifying the determined physical measurement included in the digital certificate, verifying a digital signature of the digital certificate using the included public key, or performing other verifications related to the digital certificate. The measurement manager 126 may generate a second digital certificate that authenticates the first digital certificate. The measurement manager 126 may send the second digital certificate to a certificate authority (CA) to be digitally signed by the CA. The first and second digital certificates may form a chain of trust that verifies the authenticity of the first digital certificate.

In some implementations, operation 210 may include determining physical measurements from multiple electronic devices 124(1)-(n). Operation 220 may include comparing each determined physical measurement of the multiple determined physical measurements to its respective predefined range. At operation 230, if the number of determined physical measurements is above a threshold number, operation 240 may include generating the digital certificate, and the digital certificate may include the multiple determined physical measurements. In some implementations, the threshold number may include all of the predefined measurements (i.e., if not all of the determined physical measurements are within their respective predefined ranges, the digital certificate may not be generated). In one implementation, the threshold number may include a percentage of the determined physical measurements (e.g., 50% of the determined physical measurements are within their respective predefined ranges, 60%, 70%, 80%, 90%, or some other percentage).

In one implementation, at operation 230, in response to the number of determined physical measurements not being above the threshold number, operation 240 may include not generating the digital certificate and may include sending data to the measurement subsystem 112. The data may include an alert that the number of determined physical measurements did not meet or exceed the threshold number, that the digital certificate was not generated, data indicating which electronic device's or devices' 124 determined physical measurement(s) did not conform to their respective predefined ranges, or other data. The measurement subsystem 112 may display an alert on a graphical user interface (GUI) of the electronic device 110 notifying a user that the number of determined physical measurements did not meet or exceed the threshold number, that the digital certificate was not generated, which electronic device's or devices' 124 determined physical measurement(s) did not conform to their respective predefined ranges, or other data.

As an example, a PCB 120 may include a microcontroller 122 with a measurement manager 126, and the PCB 120 may include three electronic devices 124(1)-(3). At operation 210, the measurement manager 126 may determine a power consumption of the first electronic device 124(1), a response time of the second electronic device 124(2), and an accuracy of the third electronic device 124(3). The power consumption of the first electronic device 124(1) may be 125 milliwatts (mW), the response time of the second electronic device 124(2) may be 3 milliseconds, and the accuracy of the third electronic device 124(3) may be 100%. At operation 220, the measurement manager 126 may compare these determined physical measurements to predefined ranges for the measurements. The measurement manager 126 may obtain the predefined ranges from the measurement subsystem 112, which may obtain them from one or more manufacturers of the electronic devices 124(1)-(3). The predefined range that corresponds to the determined physical measurement of the first electronic device 124(1) may include 115-170 mW, the predefined range that corresponds to the determined physical measurement of the second electronic device 124(2) may include 1-10 milliseconds, and the predefined range that corresponds to the determined physical measurement of the third electronic device 124(3) may include 98%-100%. The threshold number of predetermined physical measurements that should be within their respective predefined ranges in order to generate the digital certificate may be 100% (i.e., all the determined physical measurements are within their respective predefined ranges). At operation 230, the measurement manager 126 may determine that all three determined physical measurements are within their respective predefined ranges. In response, at operation 240, the measurement manager 126 may generate a digital certificate. The digital certificate may include the three determined physical measurements and the electronic device 124 from which they were taken.

As a second example, the PCB 120 may include the microcontroller 122 with the measurement manager 126, and the PCB 120 may include three electronic devices 124(1)-(3). At operation 210, the measurement manager 126 may determine a power consumption of the first electronic device 124(1), a response time of the second electronic device 124(2), and an accuracy of the third electronic device 124(3). The power consumption of the first electronic device 124(1) may be 125 mW, the response time of the second electronic device 124(2) may be 14 milliseconds, and the accuracy of the third electronic device 124(3) may be 100%. At operation 220, the measurement manager 126 may compare these determined physical measurements to predefined ranges for the measurements. The measurement manager 126 may obtain the predefined ranges from the measurement subsystem 112, which may obtain them from one or more manufacturers of the electronic devices 124(1)-(3). The predefined range that corresponds to the determined physical measurement of the first electronic device 124(1) may include 115-170 mW, the predefined range that corresponds to the determined physical measurement of the second electronic device 124(2) may include 1-10 milliseconds, and the predefined range that corresponds to the determined physical measurement of the third electronic device 124(3) may include 98%-100%. The threshold number of predetermined physical measurements that should be within their respective predefined ranges in order to generate the digital certificate may be 100% (i.e., all the determined physical measurements are within their respective predefined ranges). At operation 230, the measurement manager 126 may determine that the first and third determined physical measurements are within their respective predefined ranges, but the second determined physical measurement (i.e., the response time of the second electronic device 124(2)) was not within its predefined range. In response, at operation 240, the measurement manager 126 may not generate a digital certificate. The measurement manager 126 may send data to the measurement subsystem 112, and the data may include data indicating that the second electronic device's 124(2) predetermined measurement was 14 milliseconds, that the predefined range for the second electronic device's 124(2) response time is 1-10 milliseconds, and that the digital certificate was not generated. The measurement subsystem 112 may display, on a GUI of the computing device 110, an alert stating (1) the second electronic device's 124(2) predetermined measurement was 14 milliseconds; (2) the predefined range for the second electronic device's 124(2) response time is 1-10 milliseconds; (3) the digital certificate was not generated; and (4) the user should examine the electronic device 124(2) and consider replacing it.

In one implementation, the method 200 may be carried out at a first time. This first time may include, for example, when the PCB 120 is assembled, when the PCB 120 arrives at a supplier or retailer, when a user of the PCB 120 uses the PCB 120 for the first time, or at some other time. At a second time, which may occur after the first time, a party in possession of the PCB 120 may desire to determine whether one or more electronic devices 124(1)-(n) of the PCB 120 are authentic or are not failing. For example, a purchaser of the PCB 120 may desire to authenticate the electronic devices 124(1)-(n) and verify that the electronic devices 124(1)-(n) have not been replaced by clones or are not failing. In some implementations, at the second time, the method 500, discussed below, may be carried out to determine whether one or more of the electronic devices 124(1)-(n) are authentic or are not failing.

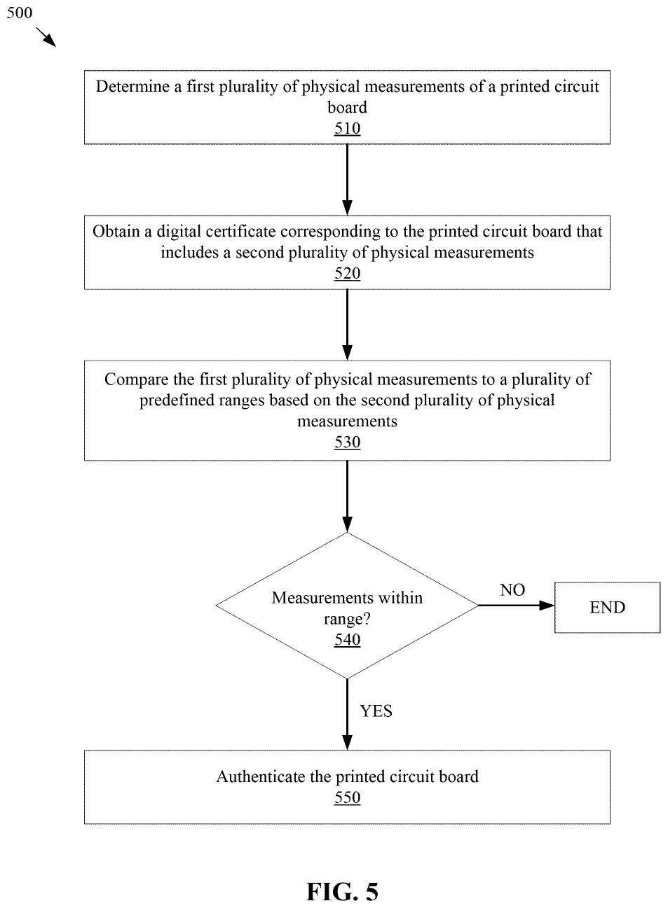

FIG. 5 depicts a flow diagram of an example method 500 for authenticating one or more electronic devices 124(1)-(n) of a PCB 120, in accordance with some implementations of the disclosure. The individual functions, routines, subroutines, or operations of the method 500 may be performed by a microcontroller, such as the microcontroller 122. The method 500 may be performed by a processing device, having one or more CPU(s) and memory devices communicatively coupled to the CPU(s). In some implementations, the method 500 may be performed by a single processing thread or alternatively by two or more processing threads, each thread executing one or more individual functions, routines, subroutines, or operations of the method. The method 500, as described below, may be performed by processing logic that may include hardware (e.g., a processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible. In some implementations, the same, different, fewer, or greater operations may be performed. It is noted that elements of FIG. 1, FIG. 3, or FIG. 4 may be used herein to help describe FIG. 5. In some implementations, the measurement manager 126 may perform one or more of the operations of the method 500.

At operation 510, processing logic determines a first plurality of physical measurements of the PCB 120. Each physical measurement of the first plurality of physical measurements may correspond to an electronic device 124 of the one or more electronic devices 124(1)-(n) of the PCB 120. Determining a physical measurement of an electronic device 124 may include similar functionality to operation 210 of the method 200. As discussed above in relation to the method 200, the physical measurement may include a power consumption, a response time, a clock parameter, an accuracy, or some other measurement of the electronic device 124.

At operation 520, processing logic obtains a digital certificate corresponding to the PCB 120. The digital certificate may include a second plurality of physical measurements. The digital certificate may include the digital certificate generated at operation 240 of the method 200. The digital certificate may serve as an attestation of the authenticity of some of the one or more electronic devices 124(1)-(n) when the digital certificate was generated. The second plurality of physical measurements may include the determined physical measurements of the one or more electronic devices 124(1)-(n) at the first time, discussed above.

At operation 530, processing logic compares the first plurality of physical measurements to a plurality of predefined ranges based on the second plurality of physical measurements. In some implementations, the first plurality of physical measurements may be compared to predefined ranges instead of being compared directly to the second plurality of physical measurements of the digital certificate because such direct comparisons may result in one or more false positives that an electronic device 124 has been replaced by a clone or that the electronic device 124 may be failing. A false positive may occur because an electronic device 124, although genuine and in good working condition, may have degraded over time or may have degraded due to use. Thus, operation 530 may compare the first plurality of physical measurements to a plurality of predefined ranges.

In one implementation, the measurement manager 126 may generate the plurality of predefined ranges. The plurality of predefined ranges may be based on data received from the measurement subsystem 112 or the data storage 130. The data may include data from one or more manufacturers of the electronic devices 124(1)-(n) that may indicate how the measurement manager 126 should generate the predefined ranges. The data may include tolerance windows, expected physical measurements for the electronic devices 124(1)-(n) based on their ages or use, or other data.

In some implementations, responsive to the digital certificate including a creation date older than a predetermined length of time, processing logic adjusts one or more of the predefined ranges of the plurality of predefined ranges. Adjusting a predefined range may include increasing the lower end of the range or increasing the upper end of the range. Adjusting the predefined range may include shifting the range up or down. This may account for the relevant electronic device's 124 age or use.

At operation 540, processing logic determines whether each physical measurement of the first plurality of physical measurements is within the predefined range that corresponds to the physical measurement. Operation 540 may include similar functionality to operation 230 of the method 200.

At operation 550, responsive to each physical measurement of the first plurality of physical measurements being within the predefined range that corresponds to the physical measurement, processing logic authenticates the PCB 120. In some implementations, processing logic may authenticate the PCB 120 in response to a predetermined number of first physical measurements being within their respective predefined range. The predetermined number may be 50% of the first plurality of physical measurements, 60%, 70%, 80%, 90%, or some other percentage. In one implementation, authenticating the PCB 120 may indicate that none of the plurality of electronic devices 124(1)-(n) have been modified since the digital certificate was generated or that none of the plurality of electronic devices 124(1)-(n) are failing.

In one implementation, authenticating the PCB 120 at block 550 may further include the measurement manager 126 deriving a cryptographic key from the first plurality of physical measurements. The measurement manager 126 may then verify the cryptographic key using a public key extracted from the digital certificate. Verifying the cryptographic key may include verifying that the extracted public key can verify or decrypt data signed by the cryptographic key.

In one implementation, an electronic device 124(1) of the plurality of electronic devices 124(1)-(n) may include a nonvolatile memory that includes a software image. The digital certificate may include a first digest of the software image. The first digest may include a hash or some other data capable of attesting to the integrity of the software image. At operation 530, comparing the first plurality of physical measurements to the plurality of predefined ranges may include the measurement manager 126 causing the generation of a second digest of the software image. The measurement manager 126 may compare the first digest to the second digest. In response to the first digest and second digest not matching, at operation 550, processing logic may not authenticate the PCB 120.

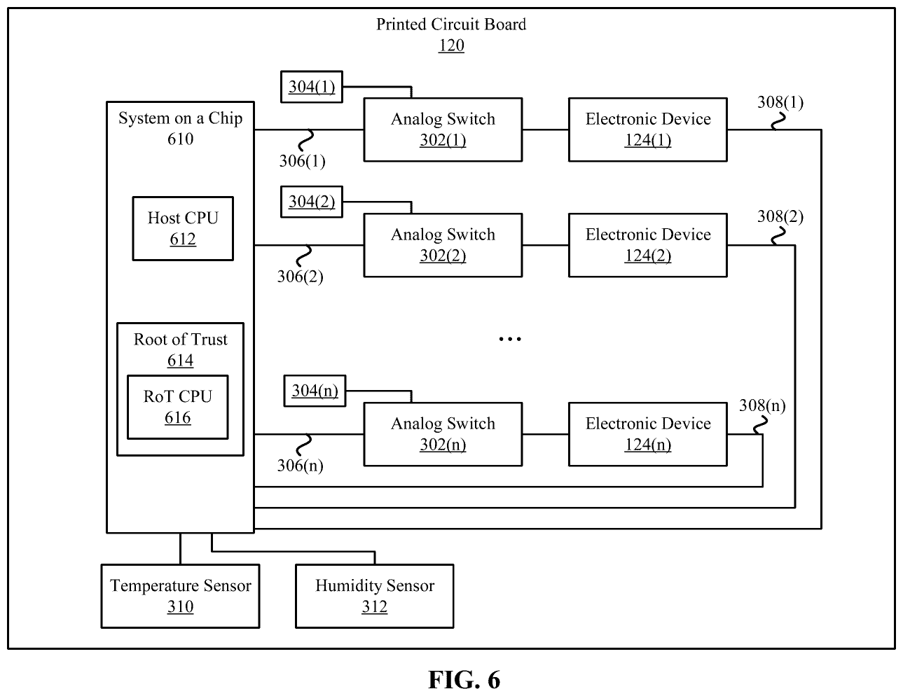

FIG. 6 depicts an illustrative PCB 120. As can be seen in FIG. 6, in some implementations, the PCB 120 may include a system on a chip (SoC) 610. The SoC 610 may include a host CPU 612. The SoC 610 may include a root of trust (RoT) 614. The RoT 614 may include an RoT CPU 616.

In one implementation, the SoC 610 may include an IC that combines one or more of the components of a computing device into a single chip. Such components may include one or more processors (e.g., the host CPU 612 or the RoT CPU 616), memory, I/O ports, or other computing device components. The host CPU 612 may include a CPU of the SoC 610. The host CPU 612 may execute a high-level operating system (HILOS).

In some implementations, the RoT 614 may include a stand-alone security module or may include a security module implemented on the SoC 610. The RoT 614 may include a fixed function RoT, which may include firmware-controlled execution. The RoT 614 may include a programmable RoT, which may include a RoT CPU 616-controlled execution. In some implementations, the RoT 614 may be configured to execute certain operations within a dedicated security domain. The operations may include cryptographic operations such as encrypting or decrypting data, generating or validating a digital certificate, generating or managing cryptographic keys, enabling a secure boot process of the SoC 610, performing secure hashing algorithm computations, or other operations.

In some implementations, the PCB 120 may include one or more components described above in relation to FIG. 3. Such components may include one or more electronic devices 124(1)-(n), one or more analog switches 302(1)-(n), one or more power supply lines 304(1)-(n), one or more channels 306(1)-(n), a temperature sensor 310, or a humidity sensor 312. The SoC 610 may include one or more of the interfaces or channels that were included in the microcontroller 122.

In some implementations, the measurement manager 126 may execute in the RoT 614. For example, one or more program instructions of the measurement manager 126 may be stored in a memory of the RoT 614, and the RoT CPU 616 may execute one or more of those program instructions. The measurement manager 126 may perform the method 200 or the method 500 in the RoT 614. The measurement manager 126 executing in the RoT 614 may provide security for the operations of the measurement manager 126.

In some implementations, the measurement manager 126 may include one or more digital measurements in the digital certificate generated at operation 240 of the method 200. A digital measurement may include a digital measurement of the one or more electronic devices 124(1)-(n) or may include a digital measurement of another component of the PCB 120. A digital measurement may include system configuration data of a component of the PCB 120, electronic device 124 configuration data, a state of a component of the PCB 120 or an electronic device 124 (e.g., a program state, a digital logic circuit state, the state of a memory, etc.), or a software image (e.g., a software image's hash).

It should be noted that, although FIGS. 1, 3, 4, and 6 depict that a PCB 120 may include a number, n, of electronic devices 124, n analog switches 302, n power supply lines 304, n channels, n sense resistors 308, or n communication lines 402, this does not necessarily mean that the PCB 120 has the same number of electronic devices 124, analog switches 302, power supply lines 304, channels, sense resistors 308, or communication lines 402. In some implementations, the numbers of these components may be different from one another. For example, multiple electronic devices 124(1)-(3) may connect to a single analog switch 302(1). Thus, herein, the use of the range “(1)-(n)” for these various components of the PCB 120 signifies only that the PCB 120 may include one or more of such components.

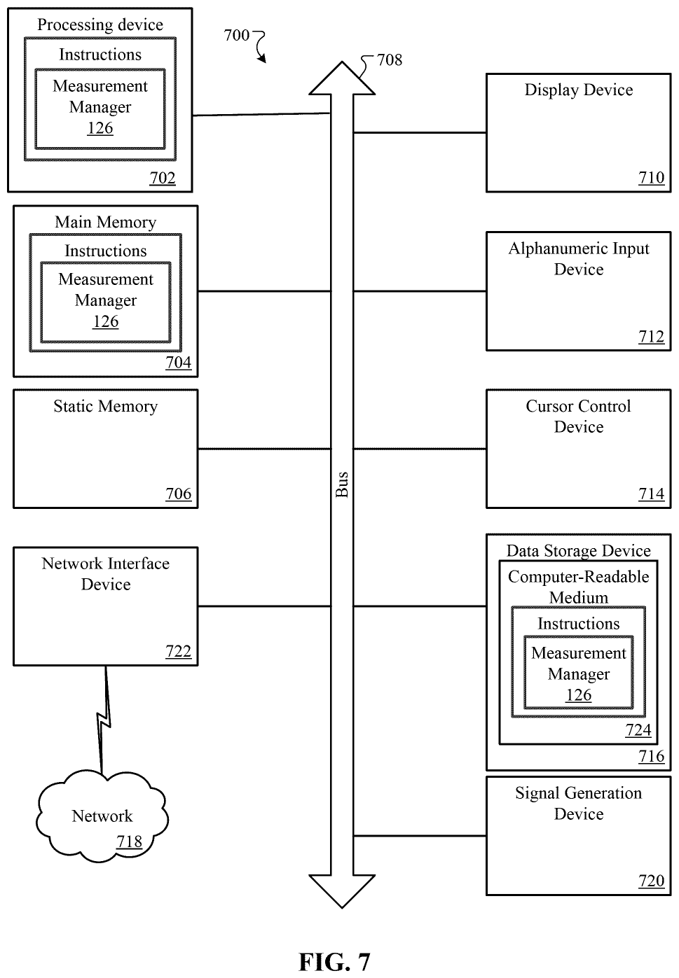

FIG. 7 is a block diagram illustrating an example computer system 700, in accordance with some implementations of the disclosure. The computer system 700 executes one or more sets of instructions that cause the machine to perform any one or more of the methodologies discussed herein. The terms “set of instructions,” “instructions,” and the like may refer to instructions that, when executed by the computer system 700, cause the computer system 700 to perform one or more operations of the measurement subsystem 112 or the measurement manager 126. The machine may operate in the capacity of a server or a client device in a client-server network environment, or as a peer machine in a peer-to-peer (or distributed) network environment. The machine may be the computing device 110, the microcontroller 122, the SoC 610, or some other machine. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein. The instructions can include the measurement subsystem 112, the measurement manager 126, the RoT 614, or some other set of instructions.

The computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 716, which communicate with each other via a bus 708.

The processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 702 may also be one or more special-purpose processing devices such as an application specific integrated circuit (ASIC), a field programmable gate array (FPGA), a digital signal processor (DSP), network processor, or the like. The processing device 702 is configured to execute instructions of the architecture 100 for performing the operations discussed herein.

The computer system 700 may further include a network interface device 722 that provides communication with other machines over the network 150, discussed herein. The computer system 700 also may include a display device 710 (e.g., a liquid crystal display (LCD) or a cathode ray tube (CRT)), an alpha-numeric input device 712 (e.g., a keyboard), a cursor control device 714 (e.g., a mouse), and a signal generation device 720 (e.g., a speaker).

The data storage device 716 may include a non-transitory computer-readable storage medium 724 on which is stored one or more sets of instructions of the architecture 100 embodying any one or more of the methodologies or functions described herein. The sets of instructions may also reside, completely or at least partially, within the main memory 704 and/or within the processing device 702 during execution thereof by the computer system 700, the main memory 704 and the processing device 702 also constituting computer-readable storage media. The sets of instructions may further be transmitted or received over the network 718 via the network interface device 722. The network 718 may include the network 140 of the system 100.

While the example of the computer-readable storage medium 724 is shown as a single medium, the term “computer-readable storage medium” may include a single medium or multiple media (e.g., a centralized or distributed database, and/or associated caches and servers) that store one or more of the sets of instructions. The term “computer-readable storage medium” may include any medium that is capable of storing, encoding or carrying a set of instructions for execution by the machine and that cause the machine to perform any one or more of the methodologies of the disclosure. The term “computer-readable storage medium” may include, but not be limited to, solid-state memories, optical media, and magnetic media.

It should be noted that some of the computer systems 700 of the PCB 120 may not include one or more of the components of the computer system 700 of FIG. 7. For example, the microcontroller 122 or the SoC 610 may not include a display device 710, alpha-numeric input device 712, or a cursor control device 714.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating,” “providing,” “receiving,” “obtaining,” “identifying,” “determining,” “sending,” “enabling,” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The word “example” or similar terms are used herein to mean serving as an example, instance, or illustration. Any aspect or design described herein as “example” is not necessarily to be construed as preferred or advantageous over other aspects or designs. Rather, use of the word “example” or other similar wording is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure may occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional implementations, one or more processing devices for performing the operations of the above-described implementations are disclosed. Additionally, in implementations of the disclosure, a non-transitory computer-readable storage medium stores instructions for performing the operations of the described implementations. Also in other implementations, systems for performing the operations of the described implementations are also disclosed.

It is to be understood that the above description is intended to be illustrative, and not restrictive. Other implementations will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
determining a physical measurement of an electronic device;
comparing the determined physical measurement to a predefined range for the physical measurement of the electronic device; and
responsive to the determined physical measurement being within the predefined range, generating a digital certificate, wherein the digital certificate comprises the determined physical measurement to be extracted from the digital certificate to verify whether the electronic device is authentic.

2. The method of claim 1, wherein:
the method further comprises generating, based on the determined physical measurement, a cryptographic key pair comprising a public key and a corresponding private key; and
the digital certificate further comprises the public key.

3. The method of claim 2, further comprising signing the digital certificate using the private key.

4. The method of claim 1, wherein generating the digital certificate comprises a root of trust generating the digital certificate.

5. The method of claim 1, wherein:
the physical measurement of the electronic device comprises a power consumption of the electronic device; and
determining the physical measurement of the electronic device comprises:
setting a supply voltage of the electronic device to a predetermined value, and
measuring the power consumption of the electronic device during execution of one or more electronic device operations.

6. The method of claim 5, wherein the one or more electronic device operations comprise at least one of:
reading data from the electronic device;
writing data to the electronic device; or
deleting data from the electronic device.

7. The method of claim 1, wherein:
the physical measurement of the electronic device comprises a clock parameter of the electronic device; and
determining the physical measurement of the electronic device comprises:
sending data to the electronic device, and
measuring a response time of the electronic device.

8. A system, comprising:
a memory device; and
a processing device, coupled to the memory device, to perform operations, comprising:
determining a physical measurement of an electronic device;
comparing the determined physical measurement to a predefined range for the physical measurement of the electronic device; and
responsive to the determined physical measurement being within the predefined range, generating a digital certificate, wherein the digital certificate comprises the determined physical measurement to be extracted from the digital certificate to verify whether the electronic device is authentic.

9. The system of claim 8, wherein the electronic device comprises an integrated circuit.

10. The system of claim 8, wherein:
a printed circuit board includes the electronic device; and
the printed circuit board further includes a microcontroller in data communication with the electronic device.

11. The system of claim 10, wherein the microcontroller comprises the memory device and the processing device.

12. The system of claim 10, wherein the processing device performs the operations during each boot process of the microcontroller.

13. The system of claim 8, wherein the operations further comprise:
receiving a temperature measurement from a temperature sensor; and
adjusting the determined physical measurement based on the temperature measurement.

14. The system of claim 8, wherein the operations further comprise:
receiving a humidity measurement from a temperature sensor; and
adjusting the determined physical measurement based on the humidity measurement.

15. A non-transitory computer-readable medium comprising instructions that, responsive to execution by a processing device, cause the processing device to perform operations, comprising:
determining a first plurality of physical measurements of a printed circuit board, wherein each physical measurement of the first plurality of physical measurements corresponds to one of a plurality of electronic devices of the printed circuit board;
obtaining a digital certificate corresponding to the printed circuit board, wherein the digital certificate comprises a second plurality of physical measurements;
comparing the first plurality of physical measurements to a plurality of predefined ranges based on the second plurality of physical measurements; and
responsive to each physical measurement of the first plurality of physical measurements being within the predefined range that corresponds to the physical measurement, authenticating the printed circuit board.

16. The computer-readable medium of claim 15, wherein the operations further comprise:
deriving a cryptographic key from the first plurality of measurements;
verifying the cryptographic key using a public key extracted from the digital certificate.

17. The computer-readable medium of claim 15, wherein the operations further comprise, responsive to the digital certificate including a creation date older than a predetermined length of time, adjusting one or more of the plurality of predefined ranges.

18. The computer-readable medium of claim 15, wherein:
an electronic device of the plurality of electronic devices comprises a nonvolatile memory that includes a software image;
the digital certificate further comprises a first digest of the software image; and
comparing the first plurality of physical measurements to the plurality of predefined ranges comprises generating a second digest of the software image and comparing the first digest to the second digest.

19. The computer-readable medium of claim 15, wherein authenticating the printed circuit board indicates that none of the plurality of electronic devices have been modified since the digital certificate was generated.

20. The computer-readable medium of claim 15, wherein:
the physical measurement of one of the plurality of electronic devices comprises an accuracy of the electronic device; and
determining the physical measurement of the electronic device comprises:
writing a block of data to the electronic device;
reading the block of data from the electronic device; and
determining whether the written block of data matches the read block of data.
